(19) United States
(12) Patent Application Publication
(10) Pub. No.: US 2009/0127508 A1
(43) Pub. Date: May 21, 2009

(54) Novel materials used for emitting light

(75) Inventor: Frank Kubel, Wien (AT)

Correspondence Address: BROWDY AND NEIMARK, P.L.L.C.;624 NINTH STREET, NW, SUITE 300, WASHINGTON, DC, 20001-5303, US

(73) Assignees: ETeCH AG, Schlieren (CH); Technische Universitacy Wien, Wien (AT)

(21) Appl. No.: 11/912,280

(22) PCT Filed: Apr. 20, 2006
(86) PCT No.: PCT/EP06/61718

§ 371 Date: Jun. 30, 2008

Related U.S. Application Data
(60) Provisional application No. 60/672,986, filed on Apr. 20, 2005.
(60) Provisional application No. 60/683,786, filed on May 24, 2005.

(51) Int. Cl. C09K 11/61

(52) U.S. Cl. 252/301.4 H

(57) ABSTRACT

An luminescent composition comprises a mixture of two or more materials, emitting electromagnetic radiation when subject to stimuli, wherein the spectral emission is not calculable at a first approximation as the simple weighted sum of the spectral emissions of the materials independently subject to said stimuli. Especially advantageous compositions are achieved if the anionic matrix is an oxide and the doping anionic salt is a fluoride or vice versa.

### TECHNICAL FIELD OF THE INVENTION

The invention relates to a material emitting electromagnetic radiation, particularly visible light, when provided with a stimulus.

### TECHNICAL BACKGROUND

It is known that certain materials, including natural minerals, emit electromagnetic radiation, particularly visible light (electromagnetic radiation in the human-visible part of the spectrum, wavelengths approximately 400 nm-700 nm), when provided with an appropriate stimulus. This stimulus can be electromagnetic radiation of a differing nature, normally of a lower wavelength (higher frequency), where the phenomenon is termed fluorescence or phosphorescence, and where the energizing radiation may be e.g., ultra-violet light: the stimulus may also be of e.g., energetic electrons or ions, the former involving either direct (electrical circuit) or indirect (electron bombardment) electrical contact. Other stimuli are also possible.

For the purposes of lighting, particularly the lighting of interior or partially enclosed spaces, it has for a long time been desirable to find or create materials which, singly or in mixtures, produce white light in the human visible region. Many such materials have been found, but they have tended to be regarded as less than ideal because of consideration of longevity, spectral shift over time, limited range of conditions of use, etc. Consequently the search for improved materials continues.

One particular application for which improved materials are required is that of fluorescent lamp bulbs. These (usually a solid solution of Mn & Sb in calcium fluoroapatite) currently work by means of ionic bombardment and/or ultraviolet light stimulation from a gas containing mercury vapour. Mercury is classified as a hazardous material, and it is desirable (and, indeed, in some legal jurisdictions, mandated) that the manufacture and use of lamp bulbs containing mercury should cease once a suitable (economically sensible, and environmentally less damaging) substitute is found, e.g., a fluorescent lamp bulb which works with nitrogen gas and noble gas without using mercury vapour. One problem with implementing this change is that the known and existing phosphors, largely developed for use with mercury vapour, do not perform well in other systems.

Fluorescent oxide systems are well known, as are fluorescent halide systems, particularly barium halide systems. The doping of oxides with oxides is also well known, and the doping of fluorides with fluorides to create e.g., barium (mixed halide) systems such as BaFCl has also been disclosed as is the further doping of such systems with rare earth elements—BaFCl doped with Sm(II) is a classic, stable, red fluorescent material. It is mentioned in U.S. Pat. No. 5,543,237, that a material with a cross-doping of fluorides with oxides might create a fluorescent oxide system, although all embodiments in said document relates to doping of fluorides with fluorides.

Most systems known and studied which are capable of electromagnetic radiation emission under certain stimuli are oxides, where the number of disclosures is great. For instance, a new blue-white material, Sr₂CeO₄ (and its Eu-doped form) were announced by Symyx in 1998 after having tested 25,000 rare earth mixed oxides for fluorescence using combinatorial chemistry.

The class of materials which does not use oxides but which uses halides has received much less study, but has been previously disclosed. Much of this work has concentrated on substitution of halides and doping in the system BaF₂, a well-known phosphorescent material, to create hitherto unknown structures, superlattices and consequent effects.

The use of mixed halides, in particular the use of chlorine and fluorine together, has been disclosed to a limited extent. In 1997 a group at the Department of Physical Chemistry at the University of Geneva, including Prof. Hans Bill and Prof. Frank Kubel, filed for and subsequently obtained a patent (WO 99/17340, priority date 29.9.1997) and published structures in 1998, showing new white fluorescent materials (and devices based on them) based on the barium-7 system, particularly Ba₇F₁₂Cl₂, these specifically being of the nature Ba_{7-x-y}MₓEu_{y}F₁₂ClᵤBrᵥ where M is one of Ca, Mg, Sr and Zn, and x, u and v are in the range 1-2, with u+v=2, and y is between 0.00001 and 2. This patent thus also discloses the use of triple mixed halides, and of double doping, within the limited range of the Ba-7 system and where one of the dopants is Eu and where the second dopant is one of Ca, Mg, Sr and Zn. This is the only known material which works with nitrogen gas (as the main constituent—some noble gases e.g., Ar, Xe, are used in the mixture for control purposes) in fluorescent lamps. The same group published in 1999 work on the barium-12 system, particularly Ba₁₂F₁₉Cl₅. This work discussed a class of materials involving barium (mixed halides) where primary doping, with Europium, has been disclosed. The barium-1, barium-7 and barium-12 systems are those known within the barium halide systems.

### SUMMARY OF THE INVENTION

Based on the above mentioned prior art it is an object of the invention to provide a better fluorescent material. A further object is to provide a better material for a luminescent composition. A further object is to provide a method to induce emission of electromagnetic radiation.

The inventors have the insight that the light emission from these structures is, in the absence of (weak) effects caused by defects, caused by the introduction of doping elements, for preference rare-earth cations, for preference europium: however these rare-earth cations must reside in a position in the lattice which is strongly polar i.e., non-centro-symmetric, to show strong optical character and confer this on the material as a whole.

There are various means of preparing such structures, which either rely on introducing the dopant cation into the matrix in its final form, or introducing it in a different chemical form and then converting it in situ. In the case of europium, where the Eu²⁺ cation is desired, the second route is favoured, the Eu being introduced as Eu(III) (during e.g., precipitation of the main structure) and then reduced in situ by a reduction step at 700° C. or directly by doping with stable EuF₂.

Other examples of fluorescent materials include (all doped with Eu²⁺) Ba₂SiO₄ doped with Eu²⁺, Sr₂SiO₄, SrAlF₅, BaMgF₄ (blue), BaSiO₃, BaMgF₄, SrMgF₄ (blue), and SrAlF₅, Ba₆Mg₇F₂₆ (blue to white) and all solid solutions within this system.

This disclosure adds and claims the following new materials:
The strontium aluminate, SrAl₂O₄ system doped with Eu²⁺ (as either the oxide or the fluoride) shows bright white emission.
Strontium aluminum silicates, notably Sr₂Al₂SiO₇, SrAl₂Si₂O₈, and Sr₃Al₁₀SiO₂₀ (this last a new compound), doped with Eu²⁺, which show respectively orange/green, weak red, and yellow luminescence under 254 nm and 366 nm UV stimulation.

All of the above work has, however, proceeded upon direct substitutional lines: that is, the introduction in principle of a single new element e.g., europium, into a pre-existing crystal (or the forming of the same in situ), without introducing disruption via the anion; thus using europium fluoride as substituent into fluoride matrices, or europium oxide into oxide matrices. The choice of the counter-ion of the dopant has always conventionally been the same as the dominant anion of the matrix, to allow ease of fabrication with minimal disruption. The limited use of double doping has proceeded along the same lines.

The disadvantage of this approach is that it is now known that, in order for the doped rare earth cation e.g., europium, to be optically active, as noted above, it must reside in an area of local symmetry which is decidedly polar, i.e., non-spherically-symmetric. Direct doping or that with matching anions does not provide this to any dependable extent; doping with other cations (e.g., dysprosium as well as europium) does to some extent. However, since it has been shown by recent work that substances such as europium fluoride EuF₂ diffuse as a linked pair within structures, if follows that doping using such a pair structure within a matrix or crystal lattice of differing anionic structure must necessarily create a strongly polar local symmetry for the Eu cation (the F taking up an adjacent oxide position within the local lattice). Thus in particular, oxides doped with fluorides show strong optically active properties. This is important because although generally the fluorides show strong optical activity, they tend to be, as noted above, unstable over time: the oxides are much more stable but show weaker effects. By the pre-sent means the virtues of the two systems can be simultaneously expressed, a further advantage being that low levels of pair-doping (because the doping occurs as pairs) is needed to manifest a strong optical effect.

The observations in such systems are recent, and so the exact nature of the chemical compounds and their structures are still the subject of theory and academic debate, but their exact nature does not prevent or predetermine this disclosure. It should be noted that, unlike many classical material systems, the optically active systems, like their natural counterparts, are difficult to describe in precise crystallographic terms, their optical activity and thus their usefulness arising rather from the irregularities and defects in the structures than from any regular features.

The present disclosure is thus for an entirely novel class of materials which are capable of emitting electromagnetic radiation under appropriate stimuli. Notwithstanding any other potential uses of the materials, e.g., to emit light under electronic or electromagnetic stimulation, one particular disclosure is that certain of these materials demonstrate the desirable characteristics of stable emission under ultra-violet light/ionic stimulation from ions other than those arising from mercury vapour, thus permitting stable white light produced by fluorescence without involving the use of mercury.

The novel class of materials in particular includes those obtained by the use of doping oxides with fluorides, possibly also using further doping elements.

This disclosure thus claims all novel systems obtained by cross-doping of anions, in particular the doping of fluorides into oxides, together with the use of doping using one or more further elements in them, and the novel class of materials obtained by this use of doping. It further claims the emission of electromagnetic radiation from such materials under suitable stimuli, and devices incorporating these materials and effects.

Synthesis of the systems studied is made by ceramic methods from reagent grade starting materials in inert (corundum, platinum, graphite) crucibles. Reduction is made in a nitrogen-hydrogen furnace.

### SHORT DESCRIPTION OF THE DRAWINGS

FIG. 1 shows the emission spectrum on 330 nanometer excitation for a phase mixture of above mentioned Ba_{12.25}Al_{21.5}Si_{11.5}O₆₆/BaAl₂Si₂O₈/BaAl₂O₄.

FIG. 2 shows the spectrum of said system with its intensity in relative strength (y-axis) against the wavelength in nanometer (x-axis).

FIG. 3 shows three X-ray diffraction spectra for Ba_{13.3}Al₃₀Si₆O₇₀, one measured spectrum, one simulated spectrum and the difference spectrum.

FIG. 4 shows three X-ray diffraction spectra for Ca₂SiO₄, one measured spectrum being almost identical to a simulated spectrum and the difference spectrum.

FIG. 5 shows three X-ray diffraction spectra for Ba_{12.25}Al_{20.5}Si_{11.5}O₆₆, one measured spectrum, one simulated spectrum and the difference spectrum.

FIG. 6 shows three X-ray diffraction spectra for Ba₂SiO₄, one measured spectrum being almost identical to a simulated spectrum and the difference spectrum.

FIG. 7 shows three X-ray diffraction spectra for Sr₂SiO₄, one measured spectrum being very similar to a simulated spectrum and the difference spectrum.

FIG. 8 shows the emission spectrum on 254 nm excitation for SAS doped with Eu.

FIG. 9 shows a X-ray diffraction spectrum for the blue emitting SAS phase showing pure powder.

FIG. 10 shows emission for sample GW004.

FIG. 11 shows an excitation spectrum of sample W1; and

FIG. 12 shows an emission spectrum of sample W1.

### DETAILED DESCRIPTION OF EXEMPLARY EMBODIMENTS

To demonstrate the validity of this approach a wide number of systems have been studied, which include:
The alkaline earth ortho-silicates, notably Ca₂SiO₄, Sr₂SiO₄ and Ba₂SiO₄, doped with Eu²⁺, where the dopant may be either the fluoride or the oxide of the rare earth metal (to show the fluoride-into-oxide heteroatom effect), the dopant concentration ranges between 0.5 mol % to 2.5 mol %, the calcination temperature ranges between 700° C. and 900° C., and the reduction temperature ranges between 900° C. and 1100° C.
In the Ba₂SiO₄ system, the emission under 254 nm and 366 nm UV is notably shifted towards higher wavelengths for the fluoridedoped systems, at all doping levels, with this being more pronounced at combination of the lowest calcination temperature and the highest reduction temperature (strong green).
In the Sr₂SiO₄ system, the fluoride doping universally shifts the emission towards higher wavelengths.
The alkaline earth simple silicates XSiO₃ and X₃SiO₅ (X is preferably Ba, Ca or Sr), doped with europium fluorides, showed mainly dark red emission.
The mixed alkaline earth/metallic earth silicate systems XYSiO₄, XYSi₂O₆, X₂YSi₂O₈, X₃YSiO₇ and X₃YSi₄O₁₂, where Y is an alkaline earth chosen from preferably Ba, Sr, and Ca, and Y is a metal such as Mg or Zn, where the final mixtures can be a mixture of any number of phases according to the above formulae, where in all cases doping was achieved by fluorides. These all show luminescence. Particular examples include:

| | | | UV | UV wave- |
|---|---|---|---|---|
| | | | wavelength | length |
| No. | System | Dopant | 254 nm | 366 nm |
| 28 | Sr₃MgSi₂O₈, Sr₂MgSi₂O₇, | Eu²⁺ | Orange | absorbing |
| | MgO | | | |
| 30 | Ca₂ZnSi₂O₇, Zn₂SiO₄, | Eu²⁺ | Grey | grey |
| | ZnO, Ca₃ZnSi₂O₈ (?) | | | |
| 31 | SrSiO₃, Sr₃MgSi₂O₈, | Eu²⁺ | pale pink | blue |
| | Sr₂MgSi₂O₇, SiO₂ | | | |
| 32 | BaSiO₃, BaMgSiO₄, | Eu²⁺ | pink | pale blue |
| | SiO₂, MgO | | | |
| 34a | BaSiO₃, BaZnSiO₄, | Eu²⁺ | greenish | yellow |
| | SiO₂, ZnO | | yellow | |
| 34b | BaSiO₃, BaZnSiO₄, | Eu²⁺ | green | yellow |
| | SiO₂, ZnO | | | |

It should be noted that various other phases were created as part of this exercise which lie beyond the simple formulae given above. A new compound, Ca₃ZnSi₂O₈ was found as part of this synthesis.
The mixed aluminates e.g., Sr₃AlO₄F, Sr₆Al₁₂O₃₂F₂, Ca₁₂Al₁₄O₃₂Cl₂, Ca₈(Al₁₂O₂₄)(WO₄)₂, (all doped with Eu)—all showed red luminescence
The yttrates and gallates such as SrY₂O₄, SrGa₂O₄, MgGa₂O₄—showed red luminescence except the Mg variants, which showed green
The borates such as Ba₂Zn(BO₃), BaZn₂(BO₃)₂ and Ba₂Zn(B₃O₆)₂ (and the Mg and Ca substituted for Zn variants)—showed red/orange luminescence
The fluorides including BaMgF₄, SrMgF₄ and Ba₇F₁₂Cl₂ doped with in this case the oxides of Sm and Eu.
BaMgF₄ (doped Sm²⁺) shows intense red
BaMgF₄ (doped Eu²⁺) shows intense blue
Ba₇F₁₂Cl₂ (doped Eu (II)+Na) shows intense white

It is possible to add or replace within all alkaline earth systems mentioned above the alkaline earth by alkaline systems.

The use of alkali flux to introduce either alkali as an dopant and/or the disorder which this introduction promotes to obtain white light rather than the blue which would be obtained in its absence is a new insight and not noted within the prior art, e.g. WO 99/17340.

It should be noted in particular that one method of obtaining a good white light source is to combine a blue/UV emitting light-emitting diode (LED) with suitable phosphor material(s) and, optionally, other light absorbing materials such as colored coatings. It is a particular feature of this invention that the choice of blue/UV LED and/or light absorbing materials are critically dependant on the light-absorbing and reemitting characteristics of the phosphor materials to the extent that two similar UV LEDs with identical specifications for peak wavelength emitted will lead to quite different light-emitting properties of the system as a whole, where these properties re not predictable from the UV LED specifications.

The various single- and multiple-component systems studied included with UV LED stimulation at nominal wavelengths between 350-405 nm:

Ba₂Si₂O₈ doped with SmF₃— gives a lilac light
BaAl₂O₄ doped with Pr—gives a blue light
SrAl₂O₄ doped with Pr³⁺—gives a deep green/blue light
SrAl₂O₄ doped with Ho³⁺—gives a dark blue/violet light
SrAl₂O₄/SrAl₁₂O₁₉—gives deep green/blue light
Sr₃Al₂₀SiO₄₀/SrAl₂Si₂O₈— gives a violet light
SrAl₂Si₂O₈/SrSiO₃/SrAl₁₂O₁₉ doped with Eu²⁺—gives a blue light
SrAl₂Si₂O₈/SrSiO₃/SrAl₁₂O₁₉ doped with La³⁺—gives a blue light
BaAl₂Si₂O₈—gives a deep blue/violet light
Ba_{12.25}Al_{21.5}Si_{11.5}O₆₆/BaAl₂Si₂O₈/BaAl₂O₄—gives a blue light (but see below)

Also claimed is a second and separate observation and the applications thereof. Up till now it has however been observed that if a mixture of two or more materials capable of emitting light in such fashion are stimulated by a means which would cause each independently to emit light, then the spectrum which results from the mixture can be determined by the independent natures and quantities of the two or more materials present. In short the emission spectrum from the mixture is reliably to a first approximation the simple weighted sum of the emissions from the individual parts, summed according to their fractional composition of the mixture, where this fractional composition may be based on e.g., mass, volume, or surface area of the components without great difference.

This understanding is used in the commercial manufacture of many lighting sources, which take as the basis for their design the assumption that if a mixture of materials is used those materials essentially act independently. This assumption has served the lighting industry well.

What has not yet been observed, and which is therefore novel and is the subject of this disclosure, is that of a mixture of two or more materials emitting light where the emitted light is NOT the simple weighted sum of the individual components provided by the individual materials independently subject to the stimulus, whatever approach to fractional composition is taken as noted above, but is significantly different.

In such cases the emitted light spectrum is not calculable by such means. In particular it is not calculable by the simple approach because the emitted spectrum from the mixture shows high emissions at wavelengths which are not typical of each of the components considered singly.

To give a specific example: a mixture of three materials, Ba_{12.25}Al_{21.5}Si_{11.5}O₆₆/Ba₂Si₂O₈/BaAl₂O₄ (proportions around 26%22%/52%), each of which would independently emit a narrow spectrum of green visible light (around 480 nm) when subject to a given ultra-violet light stimulus, when created in a mixed form and reduced, do not give a green light as those conversant with the art would have predicted, or a blue light as occurs with the unreduced co-created form, but instead give a broad spectrum of white visible light, when stimulated with UV LEDs in the range 350-405 nm. This is a significant difference from what would have been expected, since it means that the mixture is emitting, more strongly, wavelengths that it either had previously emitted weakly or not at all.

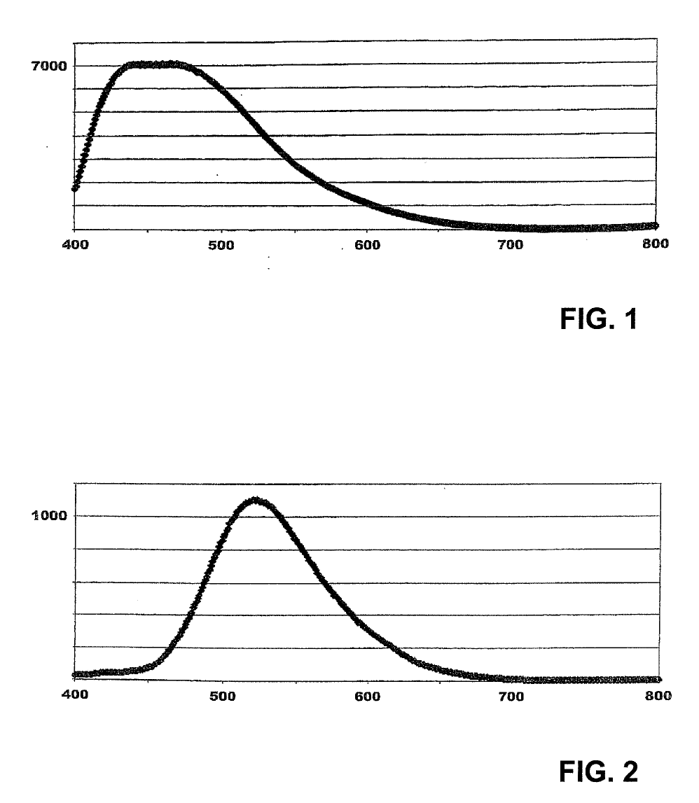

That this effect is a cooperative effect, and is not due to a new phase, can be seen from the materials analysis of the systems and from the fact that the similar system with two similar components, Ba_{12.25}Al_{21.5}Si_{11.5}O₆₆/BaAl₂Si₂O₈/BaAl₂O₄ with particular proportions also gives a blue-white light with a broad spectral peak, when stimulated with UV LED light in the range 350-405 nm, but in this case the choice of the LED used is critical, the brighter sources giving the better results, showing that a threshold stimulation may be needed for at least one component (use of weaker LEDs results in a violet light, and as noted above other compositions of the same mixture give a blue light). FIG. 1 shows the emission spectrum on 330 nanometer excitation for a phase mixture of above mentioned Ba_{12.25}Al_{21.5}Si_{11.5}O₆₆BaAl₂Si₂O₈/BaAl₂O₄. The response is white as can be seen from the broad peak in the visible wavelength, which is clearly different to the luminescence as a sum of the luminescence of the individual compounds. The spectrum shows the intensity in relative strength (y-axis) against the wavelength in nanometer x-axis).

Similarly the system SrAl₂O₄/Sr₂SiO₄, which contains none of the above constituents, gives white light under the brighter and longer wavelength UV LED stimulation in the range 350-405 nm. FIG. 2 shows the spectrum of said system with its intensity in relative strength (y-axis) against the wavelength in nanometer (x-axis).

Mixtures of BaAl₂O₄/SrAl₂O₄ across the 0-100% composition range show that between 90% and 70% BaAl₂O₄ the emission color can be noticeably shifted from the normal gold of both systems individually towards higher wavelengths, with orange emission at the 50/50 proportions.

It is clear that this effect arises through the non-independent i.e., co-operative behavior of the materials involved, where this co-operation is importantly occurring on the radiation-emission level, but, so far as can be determined, NOT on the chemical level. To be exact, the mixture, suitably analyzed to the best available ability, can be shown to remain a simple mixture, i.e., chemical reaction between the mixture components to create a new physical material not originally present, to which the unusual radiation emission might plausibly be ascribed, has not taken place, so far as it is determinable.

The phase Ba_{12.25}Al_{21.5}Si_{11.5}O₆₆, an important part of at least two of the three-component mixtures noted above, is a new specific phase and is duly claimed as such.

The observations are recent, and so the exact nature of this novel cooperative interaction is still the subject of theory and academic debate, but its exact nature does not prevent or predetermine this disclosure.

This disclosure thus claims all cases for the emission of electromagnetic radiation from mixtures of two or more materials subject to stimuli where the spectral emission is not calculable at a first approximation as the simple weighted sum of the spectral emissions of the materials independently subject to said stimuli.

A device for use of these materials can be a device comprising three individual luminescent materials, each of these three emitting within a different primary color wavelength, but preferably being pumped with one specific wavelength. It will then be possible to use e.g. a laser directed on said three materials to induce the full color response. Such a device can be described as a solid 3D display, if a laser diode is used.

### EXPERIMENTAL RESULTS

This report comprises a summary of compounds synthesized for fast and intense phosphors with high quantum yield. Compounds are mainly made of a host lattice (oxides, silicates, borates and halides including alkaline earth elements as Ca, Sr, Ba with doping/co-doping a rare earth element (Eu, Ho, . . . ) in a polar crystallographic environment. They may also be mixtures of luminescent samples or solid solutions to modify the host lattice. As a function of the matrix and the co-dopants, the phosphor colors vary from red to clear white.

The equipment comprises the following solid state synthesis equipment: several LT furnaces 1000° C., HT furnace 1600° C., H2/N2 furnace up to 1100° C., Xray diffractometer (powder—single crystal) and refinement software (TOPAS, Rietveld), Spectrometer, UV-LED system, Qant. intensity measurement device, UV lamp 2 wavelengths, Commercial Black lamp, Low tech UV “money tester”.

### Short Description of the General Procedure:

First step: Synthesis is made mainly by ceramic methods from reagent grade pure oxides/halides or precursors in adequate crucibles (corundum, platin, graphite), followed by X-ray diffraction phase analysis and preliminary UV inspection.
Control of phases and crystal size leads to the Second step: Optimization and adjustment of the synthesis.
Third step: Reduction of Eu(III) (if EU(III) was used) in a N2/H2 furnace followed by Xray analysis and UV inspection. Spectrometric analysis

In some cases different synthesis and analysis methods were used and will be explained when necessary.

The following systems were used.

Silicates and mixed silicates: XAl₂SiO₈ (X=Ba, Sr), XSiO₃ (X=Ca, Sr, Ba), X₂SiO₄ (X═Ca, Sr, Ba), Ba_{12.25}Al_{21.5}Si_{11.5}O₆₆, Sr₃Al₁₀SiO₂₀, SrAl₂SiO₇.

### Aluminates: SrAl₁₂O₁₉, XAl₂O₄ (X=Sr, Ba).

Fluorides: BaMgF₄, SrMgF₄, Ba₆Mg₇F₂₆, Ba₁₂F₁₉Cl₅, Ba₇F₁₂Cl₂.

### Borates: Ba₂Zn(BO₃)₂, Ba₂Mg(BO₃)₂.

### Silicates:

Alkaline earth ortho-silicates such as Ca₂SiO₄, Sr₂SiO₄ and Ba₂SiO₄ are promising host lattices for doping with rare earth metal ions to obtain phosphor materials. To understand the influence of various parameters on the luminescence intensity of Ba₂SiO₄: Eu²⁺ the following parameters were chosen:

Doping with the fluoride or oxide of the rare earth (F or O)
Dopant concentration (0.5 or 2.5 mol %)
Calcination temperature (700° C. or 900° C.)
Reduction temperature (900° C. or 1100° C.)

FIG. 4 shows three X-ray diffraction spectra for Ca₂SiO₄, one measured spectrum 41 being almost identical to a simulated spectrum and the difference spectrum 43. The luminescence of this system containing 100% Ca₂SiO₄ shows a very bright light blue luminescence with a high quantum output.

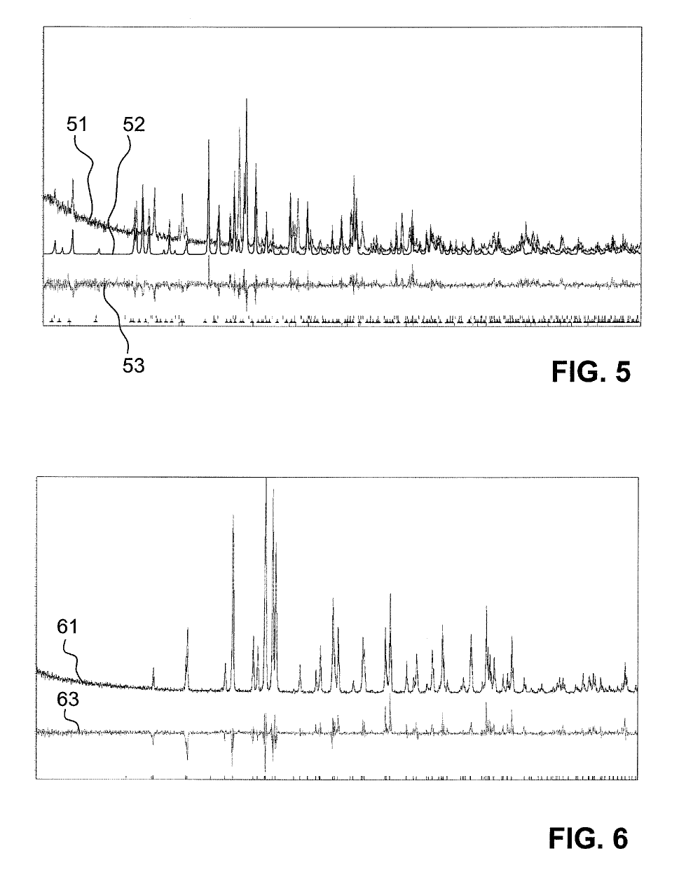

FIG. 5 shows three X-ray diffraction spectra for Ba_{12.25}Al_{20.5}Si_{11.5}O₆₆, one measured spectrum 51, one simulated spectrum 52 and the difference spectrum 53. The luminescence of this system containing 18.01% BaAl₂O₄, 11,33% Hexacelsian and 70.68 Ba_{12.25}Al_{20.5}Si_{11.5}O₆₆ shows a very bright light yellow luminescence.

FIG. 6 shows three X-ray diffraction spectra for Ba₂SiO₄, one measured spectrum 61 being almost identical to a simulated spectrum and the difference spectrum 63. The luminescence of this system containing 100% Ba₂SiO₄ shows a very intensive green luminescence with a high quantum output.

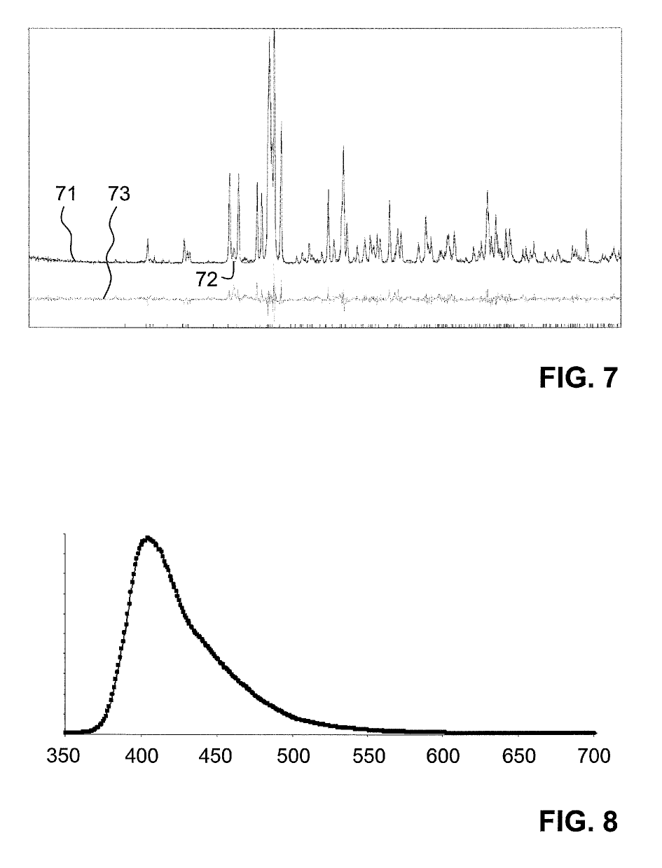

FIG. 7 shows three X-ray diffraction spectra for Sr₂SiO₄, one measured spectrum 71 being very similar to a simulated spectrum 72 and the difference spectrum 73. The luminescence of this system containing 100% Sr₂SiO₄ shows a blue-green luminescence with a good quantum output.

### Luminescent Strontium Aluminum Silicates:

Within the work on the Sr—Al-Silicates, the initially as Sr₆Al₁₈Si₂O₃₇ suspected compound is now due to single crystal measurements proven to be Sr₃Al₁₀SiO₂₀, a new compound. Doped with EuF₃ it shows a very pale greenish luminescence after excitation. Probably this compound was not pure, there was always a small amount of SrAl₂O₄ (about 5 weight %) or SrAl₁₂O₁₉. Due to this there is no certainty about the luminescent properties of the pure phase although in one case the X-Ray analysis showed absence of SrAl₂O₄ and instead SrAl₁₂O₁₉ which is already known as strong phosphor with greenish luminescence. This sample showed blue fluorescence in both wavelengths (254 and 366 nm) and yellowish-white phosphorescence. A remarkable phase is a sample containing Sr-Gehlenite (Sr₂Al₂SiO₇) doped with EuF₃. Although in this sample again we were not able to remove the small amount of SrAl₂O₄ (about 5%) the strong bright luminescence can not be only due to this small amount of byphase. To complete the work on the Sr—Al-Silicates the compounds were doped with the rare earth oxides to compare luminescent properties to the doping with fluorides. In all cases the doping with oxides gives weaker luminescent properties. The following Table shows the researched compounds.

### Strontium Aluminum Silicates:

| Assay | | | Color | | | Phosphorescence | |
|---|---|---|---|---|---|---|---|
| No. | System | Dopant | Vis | 254 nm | 366 nm | Color | Intens. |
| 38a | Sr₂Al₂SiO₇ | Eu²⁺ | White | orange, | green | pale | v. |
| | | | | yellow | | blue | strong |
| | | | | spots | | | |
| 38b | SrAl₂O₄, Al₂O₃ | Eu²⁺ | White | white | white | greenish | strong |
| | | | | | | white | |
| 40 | SrAl₂Si₂O₈ | Eu₂O₃ | White | darkred | abs., | yellow | weak |
| | | | | | white | | |
| | | | | | spots | | |
| 42 | Sr₃Al₁₀SiO₂₀ | Eu²⁺ | White | yellow | yellow | greenish | weak |

*Intensity: v. weak < weak < strong < v. strong,

### Luminescent Earthalkali and Earthalkali/Zinc Silicates:

The investigations on Silicates were broadened on the system of earth alkali and earth alkali/zinc silicates. Due to reports in literature of luminescent properties of Akermanite (Ca₂MgSi₂O₇ doped with Eu₂O₃) and Mervinite (Ca₃MgSi₂O₈ doped with Eu₂O₃) the different Earthalkali analogue of these compounds are the aim of new syntheses. This field of silicate compounds offers a large number of different possible matrices for luminescent materials. According to the structures of Akermanite and Mervinite two more systems are under found based on Orthosilicates CaMgSiO₄ and CaMgSi₂O₆. A short overview over the new field of compounds can be given as follows:

| | |
|---|---|
| 1 | XYSiO₄ |
| 2 | XYSi₂O₆ |
| 3 | X₂YSi₂O₈ |
| 4 | X₃YSiO₇ |
| 5 | X₃YSi₄O₁₂ |

X = Ba, Sr, Ca
Y = Mg, Zn

As a first step compositions 1 and 2 were screened. Substitution of Ca with Ba and Sr were tried, as well as substitution of Mg with Zn. X-Ray analysis showed that only a few of the expected phases were obtained by synthesis. The most common byproduct are the mervinites and akermanites analogue of the different earthalkalisilicates. Although luminescence properties of these two phases are mentioned in literature mostly these reports deal with doping by oxides while our compounds achieve luminescence with fluorides. And as an effect of different byproducts of the reaction the mixtures show different luminescent properties as pure phases. Some of these systems contained of up to three different phases, doping with EuF₃ showed in all cases fluorescent properties in different colors and in more than 50% of the mixtures strong phosphoresces properties in greenish to nearly white colors. The most remarkable assay of the first screening step is a composition of SrSiO₃ (8,3%), Sr₃MgSi₂O₈ (11,7%), Sr₂MgSi₂O₇ (39,1%) and a large amount of unreacted Quartz (40,7%). This sample showed very bright pale blue phosphorescence although it is only doped with EuF₃ without any codopant. In assay number 30 a new phase was found of the assumed composition Ca₃ZnSi₂O₈.

### Procedure for XYSiO₄:

A stoichiometric mixture of SrCO₃, BaCO₃ or CaCO₃ and SiO₂ was slowly heated to 1250° C. in a Al₂O₃ crucible. The reaction was kept at temperature 12 h and cooled to room temperature within 6 hours. In a reductive atmosphere in pure H₂ gas flow the grinded powders are doped with 1-2% of EuF₃.

### Procedure for XYSi₂O₆:

A stoichiometric mixture of SrCO₃, BaCO₃ or CaCO₃ and SiO₂ was slowly heated to 1050° C. in a Al₂O₃ crucible. The reaction was kept at temperature 12 h and cooled to room temperature within 6 hours. In a reductive atmosphere in pure H₂ gas flow the grinded powders are doped with 1-2% of EuF₃.

The obtained powders were analyzed with x-ray powder diffraction using a Cu K_{α1,2} radiation source.

Assay 31 has the most interesting luminescent properties:

| Assay | | | Color | | | Phosphorescence | |
|---|---|---|---|---|---|---|---|
| No. | System | Dopant | vis | 254 nm | 366 nm | Color | Int |
| 28 | Sr₃MgSi₂O₈, | Eu²⁺ | white | orange | absorbing | greenish | strong |
| | Sr₂MgSi₂O₇, MgO | | | | | | |
| 30 | Ca₂ZnSi₂O₇, Zn₂SiO₄, | Eu²⁺ | white | Grey | grey | pale | weak |
| | ZnO, Ca₃ZnSi₂O₈ (?) | | | | | yellow | |
| 31 | SrSiO₃, Sr₃MgSi₂O₈, | Eu²⁺ | white | pale | blue | pale blue- | v. |
| | Sr₂MgSi₂O₇, SiO₂ | | | pink | | white | strong |
| 32 | BaSiO₃, BaMgSiO₄, | Eu²⁺ | white | Pink | pale | greenish | strong |
| | SiO₂, MgO | | | | blue | | |
| 34° | BaSiO₃, BaZnSiO₄, | Eu²⁺ | white | greenish | yellow | green | strong |
| | SiO₂, ZnO | | | yellow | | | |
| 34b | BaSiO₃, BaZnSiO₄, | Eu²⁺ | white | green | yellow | green | strong |
| | SiO₂, ZnO | | | | | | |

*Intensity: v. weak < weak < strong < v. strong,

### Ba₁₃Al₂₂Si₁₀O₆₆ and New Orthosilicates

As a result of the investigations on Sr-Aluminosilicates and the screening processes the focus was switched to the Ba-Aluminosilicates. Previous studies showed that the emission lines of Ba compounds are broadened in relation to the Sr compounds. Nevertheless we are still looking on Sr and Ca compounds.

The work is splitted up into two major fields, first, further screening on a lot of different compounds in the rare earth doped Alkali-Aluminumsilicates as can be seen in the following table, second, to focus now on one promising phase like the system of Ba₁₃Al₂₂Si₁₀O₆₆ and it's related phases and byphases. Furthermore we revert to the latest results on Ca₂ZnSi₂O₇ and solid solutions.

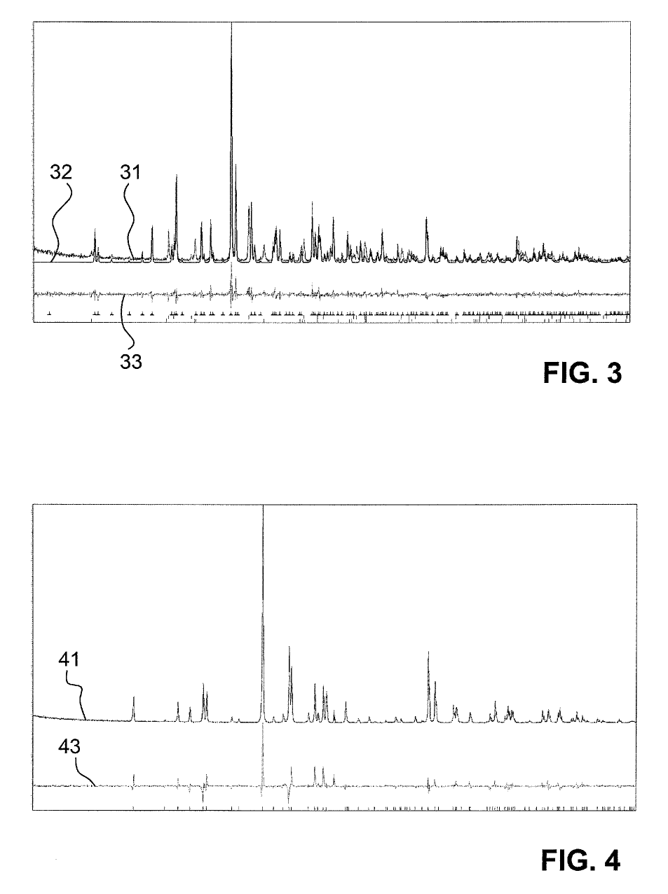

FIG. 3 shows three X-ray diffraction spectra for Ba_{13.3}Al₃₀Si₆O₇₀, one measured spectrum 31, one simulated spectrum 32 and the difference spectrum 33. The luminescence of this system containing 83.54% BA20, 9.88% BaAl₂O₄ and 6.79% Hexacelsian shows a very bright luminescence.

### Results on Ca₂ZnSi₂O₇ and Solid Solutions and Modifications:

The screening of the Manganese and Zinc compounds is finished. The theoretically assumed phases were not stable at our conditions, only the Ca₃ZnSi₂O₈ could be isolated as a new phase but did not show any remarkable new luminescent properties. The syntheses of all other samples produced only mixtures from different oxides, which were already well known by literature, like Mervinite and Akermanite.

### 2.3. Latest Results on Sr-Aluminumsilicates

To complete our investigations on Sr₃Al₁₀SiO₂₀ we tried to replace Sr with Ba and Ca to rise the phosphorescence duration and intensity. According to the size of the Ba²⁺ ion it was not astonishing that the doping did not work. The small distance between the Sr²⁺ and O²⁻ ions induce a huge stress in this structure, which agrees with the difficult synthesis. Due to this stress in structure the Ba ion would not replace the smaller Sr ion. The much smaller Ca²⁺ ion seems to replace the Sr ion in a small percentage. This can be seen in the reduction of the lattice parameter a from 15.15 to 15.08 Å. Doping with Europium and reduction with Hydrogen showed a weak increase of luminescence intensity, the color is almost the same.

### Screening of Other Compounds:

During the work on the Ba compounds, other phases are still screened. After closing the field of the Manganese and Zinc systems research was started on other Earthalkaline-Aluminumsilicates, previously found as byphases in the Sr-Aluminumsilicate synthesis. These compounds are XSiO₃ and X₃SiO₅ with X=Ca, Ba, Sr. In a first step we tried to get pure phases and dope them with Eu²⁺ in a second step. As far as results of these experiments are available, they are listed in the table below.

### Procedure:

The ground powders of carbonates and oxides are heated up to 1200° within 5 h and kept at this temperature for 14 h. To get the pure phases the grinding and heating has to be repeated twice. Doping is done with EuF₃ before the first heat treatment.

| | Color of UV excitation and phosphorescence | | | | | |
|---|---|---|---|---|---|---|
| | XSiO₃: Eu³⁺ | | | X₃SiO₅: Eu³⁺ | | |
| X = | Ba | Ca | Sr | Ba | Ca | Sr |
| 254 [nm] | red | red | red | dark red | blue | bright |
| | | | | | | red |
| 366 [nm] | dark red, | red | red | dark red | dark red | absorb- |
| | green | | | | | ing |
| | spots | | | | | |
| Phosphores- | — | — | — | red, | — | weak |
| cence | | | | strong | | |

### Ba₁₃Al₂₂Si₁₀O₆₆:

This is one of the most promising systems of the work. This phase was found as a by product on the synthesis of an assumed composition of BaAl₂SiO₆ which is not a stable phase in the Ba-Aluminosilicate system. Other byphases were BaAl₂O₄ already known as a bright greenish phosphor and BaAl₂Si₂O₈ (Hexacelsian) known as a weaker blue phosphor. The luminescence of this system containing 33% BA13, 25% BaAl₂O₄ and 42% BaAl₂Si₂O₈ shows a very bright white luminescence at 254 and 366 nm and a strong phosphorescence with a very pale blueish color. As we know that the Bariumaluminate is related to the Luminova compound we will try as a next step to replace the Aluminum with Silicate and combine it with the BA13 and the Hexacelsian. Due to earlier investigations on orthosilicates the inventors know that the Ba₂SiO₄ has similar color and intensity properties as the BaAl₂O₄. Astonishing is that the single phases show a greenish to blueish fluorescence color while an in situ synthesized mixture of all three phases is white in fluorescence. It is assumed that this effect is due to a mixture of red, green and blue emission similar to the RGB color system. Why this effect is only observed in a in situ synthesis and reduction step and not in a mixture of the pure phases is not yet clear.

A higher calcination temperature gives a higher luminescence intensity of Ba₂SiO₄: Eu²⁺ for both fluoride and oxide dopants. For fluorine dopants in Ba₂SiO₄: Eu²⁺ at low calcination temperatures a higher dopant concentration leads to a higher intensity while at 900° C. a higher dopant concentration diminishes the intensity. For oxygen dopants in Ba₂SiO₄: Eu²⁺ at low calcination temperatures a higher dopant concentration leads to a lower intensity while at 900° C. a higher dopant concentration raises the intensity.

The temperature of calcination has no influence on the specific surface area of calcined Ba₂SiO₄: Eu2+ powders. The concentration of the dopant as well as the introduction of fluorine cause a lower specific surface area and therefore bigger particle sizes of the powder.

An attempt was made to synthesize new strontium aluminum oxide fluorides. The reactions yielded the well known compounds Sr₃AlO₄F and Sr₆Al₁₂O₃₂F₂. The luminescence properties of these samples doped with EuF₃ were studied. Ca₁₂Al₁₄O₃₂Cl₂ was doped with Eu³⁺, Pr³⁺ and its luminescence behavior was investigated. Compounds with the composition M(II) M(III)₂O₄ with M(II)=Mg, Sr and M(III)=Y, Ga were doped with rare earth metals. The luminescence of these compounds was also observed under exposure to UV light. A sodalite, Ca₈(Al₁₂O₂₄)(WO₄)₂ doped with EuF₃ was studied as well.

### Sr₃AlO₄F and Sr₆Al₁₂O₃₂F₂: Eu³⁺

Mixtures of SrCO₃, SrF₂ and Al(NO₃)₃*9H₂O with 0.5 mol % EuF₃ were ground, pressed and placed in a corundum crucible. The crucible was kept at 100° C. for 24 h to release water. Then it was heated to 700° C. It was kept at that temperature for 24 hours, another 24 hours at 800° C. and another 24 hours at 900° C. The mixture was reground and fired at 1050° C. for 72 hours. The samples were reduced in a tube furnace under pure H₂ for 2 h at 1000° C.

### Ca₁₂Al₁₄O₃₂Cl₂:

A stoichiometric mixture of CaCO₃, Al(OH)₃ and CaCl₂*3H₂O was doped with 0.5 mol % of LnF₃ with Ln=Eu or Pr was ground, pressed and placed in a platinum crucible. Then it was heated to 1000° C. and kept at that temperature for 1 hour.

### Ca₈ (Al₁₂O₂₄)(WO₄)₂:

A stoichiometric mixture of CaCO₃, Al(OH)₃ and WO₃ with 0.5 mol % EuF₃ and 0.5 mol % DyF₃ was heated to 1200° C. and kept at this temperature over night. The product was ground, pressed and fired again at 1300° C. Eu³⁺ was reduced in a tube furnace under pure H₂ for 2 h at 1000° C.

### SrY₂O₄:

A stoichiometric mixture of SrCO₃ and Y₂O₃ was ground, pressed and heated to 1550° C. in a corundum crucible and kept at that temperature for 72 hours. For doping the product was mixed with the rare earth fluoride and heated in a tube furnace under pure H₂ to 1000° C. The reaction mixture was kept at this temperature for 2 hours.

### SrGa₂O₄:

A stoichiometric mixture of SrCO₃ and Ga₂O₃ was ground, pressed and heated to 1200° C. in a corundum crucible and kept at that temperature for 72 hours. For doping the product was mixed with EuF₃ and heated in a tube furnace under pure H₂ to 1000° C. The reaction mixture was kept at this temperature for 2 hours.

### MgGa₂O₄:

A stoichiometric mixture of MgCO₃ and Ga₂O₃ was ground, pressed and fired at 1000° C. in a corundum crucible for 6 hours.

### Sr₃AlO₄F and Sr₆Al₁₂O₃₂F₂: Eu³⁺

| Assay No. | Substance | Dopant | Uv-Luminescence |
|---|---|---|---|
| Sra I | Sr₃AlO₄F | EU³⁺ | red orange at 254 and 366 nm |
| Sra II | Sr₆Al₁₂O₃₂F₂ | Eu³⁺ | weak red at 366 nm, red at 254 |
| | | | nm |

### Ca₁₂Al₁₄O₃₂Cl₂:

| Assay No | Substance | Dopant | Uv-Luminescence |
|---|---|---|---|
| Ca I | Ca₁₂Al₁₄O₃₂Cl₂ | Eu³⁺ | red at 254 nm |
| Ca III | Ca₁₂Al₁₄O₃₂Cl₂ | Eu²⁺/Pr³⁺ | red at 254 nm* |

*the red color shows that it was not possible to reduce most of the Eu³⁺ in this compound

### Ca₈(Al₁₂O₂₄)(WO₄)₂:

| Assay No. | Substance | Dopant | Uv-Luminescence |
|---|---|---|---|
| W I | Ca₈(Al₁₂O₂₄) (WO₄)₂ | Eu³⁺ | dark orange at 254 nm |
| W II | Ca₈(Al₁₂O₂₄) (WO₄)₂ | Eu²⁺ | dark orange at 254 nm |

### SrY₂O₄:

| Assay No. | Substance | Dopant | Uv-Luminescence |
|---|---|---|---|
| SrY I | SrY₂O₃ | Eu³⁺ | intensive red at 254 nm |
| SrY Ii | SrY₂O₃ | Eu²⁺ | intensive red at 254 nm |
| SRY III | SrY₂O₃ | Mn²⁺ | dark red |
| SRY IV | SrY₂O₃ | Ho³⁺, Mn²⁺ | dark red |
| SRY V | SrY₂O₃ | Tb³⁺ | yellow with |
| SRY VI | SrY₂O₃ | Ce³⁺ | Absorbing |

### SrGa₂O₄:

| Assay No. | Substance | Dopant | Uv-Luminescence |
|---|---|---|---|
| SrG I | SrGa₂O₃ | Eu³⁺ | red at 254 nm |
| SRG III | SrGa₂O₃ | Ho³⁺, Mn²⁺ | absorbing |

### MgGa₂O₄:

| Assay No. | Substance | Dopant | Uv-Luminescence |
|---|---|---|---|
| Mg I | MgGa₂O₃ | | green at 254 nm |

### Sr₃AlO₄F and Sr₆Al₁₂O₃₂F₂: Eu³⁺

Several attempts were made to synthesize new strontium aluminum oxide fluorides. The products always contained Sr₃AlO₄F and Sr₆Al₁₂O₃₂F₂ and several strontium aluminates, e.g. SrAl₂O₄. The samples showed red luminescence before the reduction and some showed pale blue/white luminescence after the reduction. In some samples the red colour was not affected by the treatment with pure H₂.

### Ca₁₂Al₁₄O₃₂Cl₂:

Ca₁₂Al₁₄O₃₂Cl₂ showed red luminescence when it was doped or co-doped with Eu³⁺.

### Ca₈ (Al₁₂O₂₄)(WO₄)₂: Eu

The samples showed orange luminescence under UV light at 254 nm but no after-glow.

### SrY₂O₄:

SrY₂O₄ showed weak after-glow when it was doped with Eu²⁺ and with Tb³⁺.

### SrGa₂O₄:

The typical Eu²⁺ luminescence was not observed.

### Borates (Eu), Studies on Luminescent Ortho- and Metaborates:

Mixed borates of barium and another alkaline earth metal or zinc were synthesized and doped with rare earth metals such as europium and ytterbium. Some of the resulting powders were reduced in a tube furnace under N₂/H₂ atmosphere. The luminescence of the products was investigated using UV light with a wavelength of 254 and 366 nm.

Stoichiometric quantities of BaCO₃ and H₃BO₃ were mixed with either MgO, CaCO₃ or ZnO and 0.5 mol % of a rare earth fluoride (rare earth=Eu, Yb) and pressed to a pellet.

All syntheses were carried out in platinum crucibles. In a first step the crucibles were heated to 800° C. within 8 hours and kept at that temperature for 12 hours. After cooling the mixture was reground and pressed again. In a second firing step they were heated to 850° C. and kept at that temperature for 12 hours.

Ba₂Zn(BO₃)₂ was doped with Mn²⁺, Sm³⁺ and Eu³, in a tube furnace at 800° C. For that purpose the tube furnace was purged with pure H₂. Ba₂Mg(BO₃)₂: Eu³⁺ was reduced under the same conditions.

| say No. | Substance | Dopant | Uv-Luminescence |
|---|---|---|---|
| Ia | Ba₂Zn(BO₃)₂ | Eu³⁺ | weak red at 366 nm, |
| | | | intensive bright |
| | | | red at 254 nm |
| Ib | Ba₂Zn(BO₃)₂ | Eu³⁺; Eu²⁺ | orange at 254 nm |
| B Ic | Ba₂Zn(BO₃)₂ | Sm³⁺ | bright orange at 254 nm |
| B Id | Ba₂Zn(BO₃)₂ | Mn²⁺ | Absorbing |
| B Ii | BaZn₂(BO₃)₂ | Eu³⁺ | weak red at 254 nm |
| B IIIa | Ba₂Mg(BO₃)₂ | Eu³⁺ | red at 366 nm; intensive |
| | | | orange at 254 nm; |
| | | | red x-ray luminescence |
| B IIIred | Ba₂Mg(BO₃)₂ | Eu³⁺; Eu²⁺ | intensive orange at 366 |
| | | | and 254 nm |
| B IV | Mg₂B₂O₅; Ca₂B₂O₅ | Eu³⁺ | orange at 254 nm; red |
| | Ca(BO₂)₂ | | x-ray luminescence |
| B Va | BaZn₂(BO₃)₂ | Tb³⁺ | yellow at 254 nm |
| B Vb | BaZn₂(BO₃)₂ | Sm³⁺ | orange at 254 nm |
| B Vc | BaZn₂(BO₃)₂ | Bi³⁺ | Absorbing |
| B VI | Ba₂Mg(B₃O₆)₂ | Tb³⁺ | yellow greens |
| B VII | Ba₂Ca(B₃O₆)₂ | Tb³⁺ | yellow green |
| B VIII | Ba₂Zn(B₃O₆)₂ | Eu³⁺ | red at 254 nm |
| B IX | Ba₂Ca(BO₃)₂ | Eu³⁺ | orange at 254 nm |

The invention is based on the insight that, when talking about combinations of halides and oxides, the choice of host and dopant is not symmetrical: in short, that doping oxides into fluorides is not the same as doping fluorides into oxides. The reason is the insight that the dopant-fluoride pair travel AS A PAIR into the matrix, and hence the dopant rare-earth ion nearly always ends up in non-symmetric surroundings, which is vital for luminescence. Hence, this tends to lead to more effective—and hence efficient—materials.

Additionally further compounds have been found to exhibit luminescence according to the above mentioned principles. These are discussed and described as follows.

### SrAl₂Si₂O₈ [Eu(II)]—a Blue Phosphor

Bluish phosphors have been found in the past years by different research groups. One of these materials is SrAl₂Si₂O₈ (SAS), doped with Eu₂O₃ it emits weak blue luminescence. To improve color and intensity of this phosphor as a base for a new white light emitting material, a physical mixture of a yellow and a blue phosphor was prepared to show white fluorescence after excitation with nitrogen lamp. Improvement of the bluish SAS was done by doping it with rare earth (RE) fluorides and adding small amounts of boron acid or sodium fluoride as flux (supporting shorter reaction time) and to change color properties of the materials. Adding boron to the reaction improved synthesis time and gave all samples a pinkish touch. NaF addition had same influence on reaction progress than boron acid but shifted color of the doped samples to very pale blue—close to white—color.

An in situ prepared mixture of different silicates and aluminosilicates emits different colors than physical mixtures of the same materials creating a new intensive blue phosphor with different blue colors. While the pure phase shows weaker intensity and a slightly pink touch, the mixtures of SAS with some other silicates and aluminosilicates show more intensity or a brighter blue. Highest emission yield was obtained at 254 nm excitation. The emission peak of the SAS has its highest intensity about 405 nm (see FIG. 8) in the blue region.

| | Phase composition in % | | | | | fluorescence |
|---|---|---|---|---|---|---|
| Sample | SAS | SrSiO₃ | SrAl₂O₄ | SrAl₁₂O₁₉ | Educts | color |
| AR006 | 100 | — | — | — | — | blue |
| AR015 | 63 | 11 | 6 | 11 | 9 | pale blue |
| K2 | 68 | 14 | — | 11 | 7 | blue (strong) |

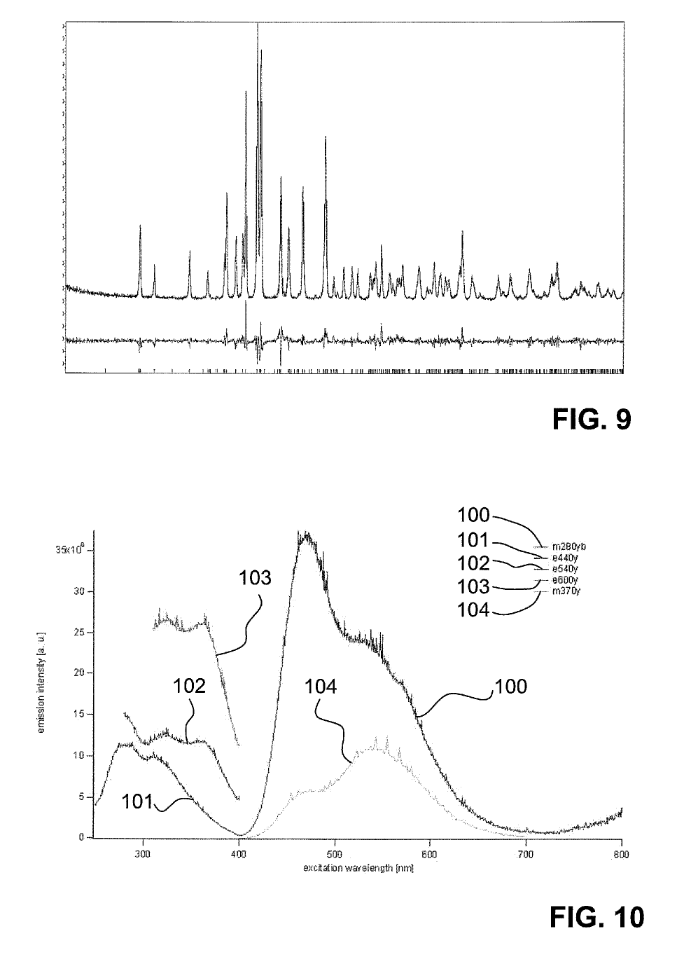

Pure SAS powders were obtained from a well homogenized mixture of pro analytical SrCO₃, Al(OH)₃ and SiO₂ powders. The powders were pressed to pellets and fired at 1450° C. for 8 h with a heating rate of 200° C./h. RE doping with EuF3 or other RE fluorides was done at 1000° C. for 2 h. XRD measurements show pure SAS phase without by products (FIG. 9).

Mixtures containing mainly SAS and other silicates or aluminosilicates, as shown in the table above, were obtained with the same educts fired at 1200° C. for 10 h. Doping was done at same conditions as above.

### Sr₂SiO₄—[Eu(II),La(III)]—a Yellow Phosphor

Stoichiometric amounts of pro analytical SrCO₃ and SiO₂, 0.5 mol % EuF₃ and 0.5 mol % LaF₃ were homogenized very well. The mixture was put into a mould and a pellet was formed at a pressure of 10 tons for 5 minutes. Thereafter the pellet was given into an aluminium oxide crucible and heated up to 1370° C. for 12 hours with a heating rate of 200° C./h. Alternatively the synthesis was done with Aerosil P300 instead of quartz at 850° C. for 36 hours time, also with a heating rate of 200° C./h.

### Both Syntheses Showed the Same Results:

A phase mixture of orthorhombic and monoclinic Strontium silicate, where the ratio of the monoclinic phase was from 75% up to 98%.

The second step of preparation was the reduction of the RE. This was done at 1000° C. for one and a half hour with a heating rate of 400° C./h. The reduced powder was homogenized once more and analyzed by powder diffraction. The phase distribution was both times the same as before reduction.

Afterwards the luminescence properties of the powder were tested by irradiation under UV at 254 nm and 366 nm. The fluorescence was a bright light yellow.

Also the phosphorescence was yellow and could be seen by the naked eye for about an hour. The phosphorescence can be depressed by adding small amounts of boric acid or iron.

FIG. 10 shows the emission for this compound, named sample GW004. It can be seen that at 280 nm there are two overlapping Eu bands (reference numeral 100). Excitation spectra measured at 440, 540 und 600 nm (i.e. 101, 102, 103) show, that at an excitation at 370 nm the second band is more intensive. The emission spectra at 370 nm confirm to this (sample GW 004; reference numeral 104).

With the two above mentioned intensive luminophores different physical mixtures were made. Mixing the yellow and the blue compound all color shades between yellow and blue were obtained. Although concerning the RGB system no red emitting material is in the mixture the obtained powders show bright white emission.

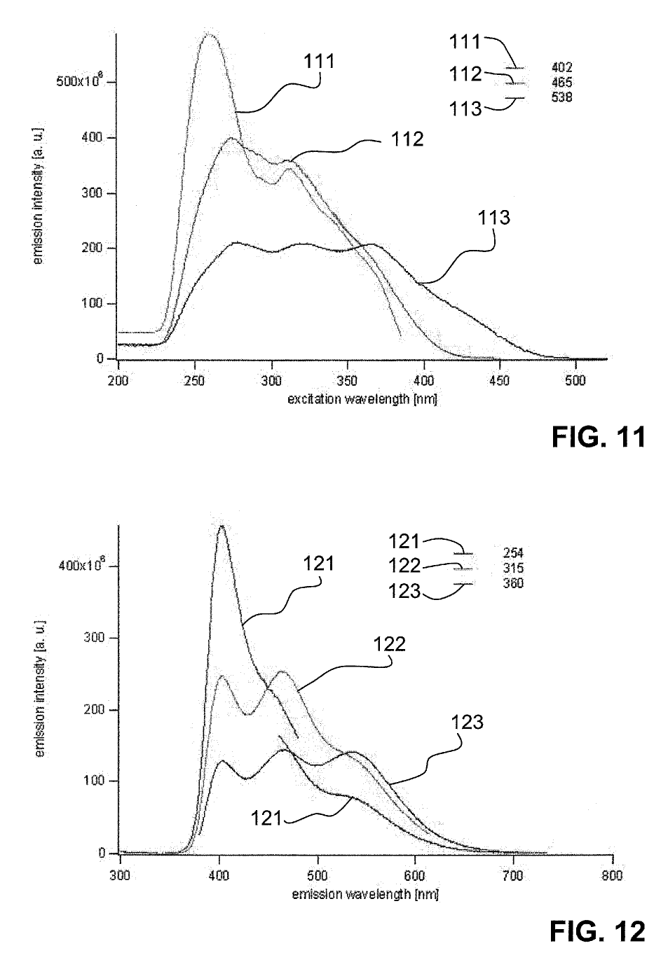

FIG. 11 shows an excitation spectrum of sample W1. The different lines 111, 112 and 113 show the excitation at 3 fixed emission wavelengths (402, 465 and 538 nm). Excitation spectra show three different broad peaks with a maximum excitation around 250 nm. These peaks can be determined as SAS excitation at 250 nm and Sr₂SiO₄ excitation at 320 and 370 nm. The Sr₂SiO₄ signal is split in two peaks presumable due to the alpha and beta phase.

FIG. 12 shows emission spectra of W1 at different wavelengths. Best results were obtained at 360 nm (reference numeral 123) were all three peaks showing same intensity. The step in the line 121 is due to switching the filter in the spectrometer. Emission spectra 121 shows a very intense peak around 400 nm under short wave irradiation with UV light at 254 nm. The best emission profile 123 was obtained under 360 nm were all peaks show the same intensity.

These compounds show non-predictable colour effects upon mixing and are formed using halide dopants in the oxide matrix. They are new in the sense that some use two, not one, cationic dopants, of which one is Eu.

Finally, a new class of highly luminescent red-emitting fluorescent materials based on aluminates have been found, based on (a) 40% CaAl₄O₇/40% CaAl₁₂O₁₉/20% Al₂O₃ doped with Mn halides and (b) Li₂Al₁₀O₁₆/LiAl₅O₈ doped with Fe (oxides, in this case, but halides also possible). Colour and luminescence vary with the amount of doping (and the wavelength of UV used to excite the materials) and furthermore, when mixed, the same mixing effects arise.

Red emitting phosphors based upon Al₂O₃ with Ca (with Mn doping) and Li (with Fe doping) have been mentioned by Virgil Mochel of the Corning Glass Works (J. Electrochem. Soc., April 1966, pp 398-9) which describes Li₂O_{0.5}Al₂O₃:Fe (thus compositionally equal to Li₂Al₁₀O₁₆, even though the actual phases may be different) and CaO_{0.2}Al₂O₃:MnCl₂ (thus equal to CaAl₄O₇, ditto). However Mochel does not disclose (a) the additional phases beyond the first in each mixture (b) the particular phase mixtures—Mochel is in particular much richer in Al2O3 in the Ca—Mn system, and (c) the post-doping with halides.

Calcium Aluminates Doped with Manganese

Starting from J. Electrochem. Soc. (1966), 113(4), 398-9 different mixtures of calcium aluminates doped with manganese were prepared.

| | | | | | Luminescence | |
|---|---|---|---|---|---|---|
| | | | | XRD results | 254 nm | 366 nm |
| AB129 | 400.4 mg | 1248 mg | 5 mg | 95.12 wt % CaAl₄O₇ | weak red | dark |
| | CaCO₃ | Al(OH)₃ | MnCl₂ | 4.88 wt % CaAl₂O₄ | | red |
| AB130 | 170 mg CaO | 830 mg | 0.5 mg | 39.49 wt % CaAl₄O₇ | dark red | strong |
| | | Al₂O₃ | MnCl₂ | 37.91 wt % CaAl₁₂O₁₉ | | red |
| | | | | 22.6 wt % Al₂O₃ | | |
| AB131 | 400.4 mg | 1248 mg | 0.5 mg | 94.42 Wt % CaAl₄O₇ | red with dark | dark |
| | CaCO₃ | Al(OH)₃ | MnCl₂ | 6.58 wt % CaAl₁₂O₁₉ | spots | red |
| AB132 | 224 mg CaO | 816 mg | 0.5 mg | 61.3 wt % CaAl₄O₇ | intensive red | strong |
| | | Al₂O₃ | MnCl₂ | 19.35 wt % CaAl₁₂O₁₉ | | red |
| | | | | 19.35 wt % Al₂O₃ | | |
| AB133 | 84 mg CaO | 918 mg | 0.5 mg | 9.85 wt % CaAl₄O₇ | intensive red | strong |
| | | Al₂O₃ | MnCl₂ | 38.06 wt % CaAl₁₂O₁₉ | | red |
| | | | | 52.1 wt % Al₂O₃ | | |
| AB135 | 224 mg CaO | 816 mg | 0.5 mg | 64 wt % CaAl₄O₇ | intensive red | strong |
| | | Al₂O₃ | MnF₂ | 20.22 wt % CaAl₁₂O₁₉ | | red |
| | | | | 15.78 wt % Al₂O₃ | | |

All powders were grinded, pressed to pellets and put into corundum crucibles. They were synthesized in air at 1370° C. for 12 h.
The following specimen were prepared of lithium aluminates doped with iron.

| | | | | | Luminescence | |
|---|---|---|---|---|---|---|
| | | | | XRD results | 254 nm | 366 nm |
| AB139 | 123.6 mg | 950 mg | 1.3 mg | 79 wt % LiAl₅O₈ | intensive | only weak |
| | Li₂CO₃ | Al₂O₃ | Fe₂O₃ | 21 wt % Al₂O₃ | red | luminescence |
| AB140 | 110.8 mg | 764.7 mg | 1.0 mg | 100% LiAl₅O₈ | intensive | only weak |
| | Li₂CO₃ | Al₂O₃ | Fe₂O₃ | | red | luminescence |

The preparation process was the same as for the calcium aluminates. The XRD results relate to Bruker AXS (2000), Topas V2.0, Karlsruhe, Germany.

1.-37. (canceled)

38. A luminescent composition emitting electromagnetic radiation when subject to appropriate electronic and/or electromagnetic stimuli, being of solid state materials based on anionic matrices, distinguished in that said matrices are altered by doping with anionic salts of rare earth metals and/or alkaline metals where the choice of anion(s) in such materials, hereafter termed ‘dopants’, is deliberately different from the anion(s) in the anionic host matrix, said doping arising from deliberate incorporation of the above dopants, as is shown by the final composition, and not accidental or impurity incorporation arising from the use of a flux during preparation.

39. The luminescent compositions according to claim 38, wherein the anionic matrix is an oxide and the doping anionic salt(s) are fluorides, or vice versa.

40. The luminescent compositions according to claim 38, which also contains a secondary cation not of the alkaline earth cations, optionally Boron, Silicon and Aluminum in which case the oxide matrix materials are ‘borates’, ‘silicates’, or ‘aluminates’, or mixed systems thereof.

41. The luminescent compositions according to claim 38, in which the cationic dopants are Europium and none or more other elements.

42. The luminescent compositions according to claim 38, made by suitable solid state manufacturing techniques, optionally precipitation, ‘shake and bake’ and sol gel.

43. The luminescent compositions according to claim 38, wherein said stimuli include at least one stimulus comprising electromagnetic radiation falling in the ultra-violet part of the spectrum, or wherein said stimuli include at least one stimulus comprising electromagnetic radiation falling at least partly in the human-visible part of the electromagnetic spectrum.

44. The luminescent compositions according to claim 38, wherein said stimuli includes at least one stimulus comprising electrons supplied via direct electrical circuit or via indirect electron bombardment.

45. The luminescent compositions according to claim 38, wherein said stimuli includes at least one stimulus comprising ions.

46. A light emitting device providing emission of electromagnetic radiation from at least one of the materials of luminescent compositions emitting electromagnetic radiation when subject to appropriate electronic and/or electromagnetic stimuli, being solid state materials based on anionic matrices, distinguished in that these matrices are altered by doping with anionic salts of rare earth metals and/or alkaline metals where the choice of anion(s) in such materials, hereafter termed ‘dopants’ is deliberately different from the anion(s) in the anionic host matrix, this doping arising from deliberate incorporation of the above dopants, as is shown by the final stated composition, and not accidental or impurity incorporation arising from the use of a flux during preparation.

47. The device according to claim 46, wherein the emitted electromagnetic radiation falls at least partly in the human-visible part of the electromagnetic spectrum and wherein said stimuli include at least one stimulus comprising electromagnetic radiation, optionally falling in the ultra-violet part of the spectrum.

48. The device according to claim 46, wherein such device is a light/lamp bulb or a fluorescent light/lamp bulb or a light-emitting diode or a solid full color display or a fluorescent paint or ink or colorant or dye or dyestuff.

49. The device according to claim 46, wherein such device produces ‘white light’ either directly or by use of a mixture of materials.

50. A material for a luminescent composition emitting electromagnetic radiation when subject to appropriate electronic and/or electromagnetic stimuli, being solid state materials based on anionic matrices, distinguished in that these matrices are altered by doping with anionic salts of rare earth metals and/or alkaline metals where the choice of anion(s) in such materials, hereafter termed ‘dopants’ is deliberately different from the anion(s) in the anionic host matrix, this doping arising from deliberate incorporation of the above dopants, as is shown by the final stated composition, and not accidental or impurity incorporation arising e.g., from the use of a flux during preparation, wherein the material comprising SrAl₂O₄, doped with one or more rare earth elements preferably in the form of fluorides, optionally for use as a bright white emitter.

51. A material for a luminescent composition emitting electromagnetic radiation when subject to appropriate electronic and/or electromagnetic stimuli, being solid state materials based on anionic matrices, distinguished in that these matrices are altered by doping with anionic salts of rare earth metals and/or alkaline metals where the choice of anion(s) in such materials, hereafter termed ‘dopants’ is deliberately different from the anion(s) in the anionic host matrix, this doping arising from deliberate incorporation of the above dopants, as is shown by the final stated composition, and not accidental or impurity incorporation arising e.g., from the use of a flux during preparation, wherein the material comprising CaAl₁₂O₁₉, optionally doped with one or more transition metals, preferably Mn and/or Fe, optionally in the form of oxides and/or halides and/or doped with one or more rare earth elements optionally in the form of fluorides.

52. The material according to claim 51, comprising a mixture of calcium aluminates, being based on 40% CaAl₄O₇/40% CaAl₁₂O₁₉/20% Al₂O₃, all doped with Mn oxides and/or halides and/or doped with one or more rare earth elements, preferably in the form of fluorides, where this material composition by itself exhibits strong red luminescence.

53. The material according to claim 51, comprising LiAl₅O₈, preferably doped with one or more transition metals, optionally Mn and/or Fe, optionally in the form of oxides and/or halides and/or doped with one or more rare earth elements optionally in the form of fluorides.

54. The material according to claim 51, comprising a mixture of lithium aluminates, being based on Li₂Al₁₀O₁₆/LiAl₅O₈, both doped with Fe oxides and/or halides and/or doped with one or more rare earth elements optionally in the form of fluorides, where this material composition by itself exhibits strong red luminescence.
